(19) United States
(12) Patent Application Publication
(10) Pub. No.: US 2025/0298648 A1
(43) Pub. Date: Sep. 25, 2025

(54) Injecting Network Environmental Variables Into Containers

(71) Applicant: Rakuten Symphony, Inc., Tokyo (JP)

(72) Inventors: Manjunath Mageswaran, San Jose, CA (US); Shravan Vallala, San Jose, CA (US); Sandeep Yelburgi, Bangalore (IN)

(21) Appl. No.: 18/250,702

(22) PCT Filed: Dec. 14, 2022
(86) PCT No.: PCT/US2022/052864

§ 371 Date: Apr. 26, 2023

(51) Int. Cl. G06F 9/455; H04L 12/46; H04L 41/0895

(52) U.S. Cl. CPC G06F 9/45558; H04L 12/4641; H04L 41/0895; G06F 2009/45562; G06F 2009/45595

(57) ABSTRACT

A pod on a host receives a pod specification annotated with network data. The pod is instantiated on the host. The pod calls a container network interface (CNI) and passes the CNI the network data. The CNI creates network interfaces according to the network data. The pod calls a container runtime interface (CRI) to instantiate containers for the pod. The CNI and CRI are implemented by an agent that retains the network data. The CRI extracts environmental variables from the network data and configures the containers to use the environmental variables.

### BACKGROUND

### Field of the Invention

This invention relates to injecting network environmental variables into containers.

### Background of the Invention

Containers are a convenient way to execute application instances in a variety of operating environments. A container is software that packages all dependencies of an application instance so that the application instance executes reliably and quickly in any given computing environment. For example, a container may include executable code, runtime, system tools, system libraries, settings, and the like that enable an application image instance to execute on a host either with or without an underlying operating system.

It would be an advancement in the art to improve the deployment of containers.

### SUMMARY OF THE INVENTION

An apparatus includes a computing device including one or more processing devices and one or more memory devices operably coupled to the one or more processing devices. The one or more memory devices storing executable code that, when executed by the one or more processing devices, causes the one or more processing devices to instantiate a pod according to the pod specification and configure one or more network interfaces for the pod according to the network annotation. The executable code causes the one or more processing devices to call a container runtime interface to instantiate one or more containers in the pod. The one or more containers are instantiated by the container runtime interface. The container runtime interface configures the one or more containers with one or more environmental variables from the network annotation for controlling communication over the one or more network interfaces.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment in which containers may be deployed in accordance with an embodiment;

FIG. 2 is a schematic block diagram showing networks that may be used by a container in accordance with an embodiment;

FIG. 3 is a schematic block diagram illustrating configuration of a pod and a container for performing network communication in accordance with an embodiment;

FIG. 4 is a process flow diagram of a method for configuring a pod and a container for performing network communication in accordance with an embodiment;

FIG. 5 is an example listing of environmental variables in accordance with an embodiment; and

FIG. 6 is a schematic block diagram of an example computing device suitable for implementing methods in accordance with embodiments of the invention.

### DETAILED DESCRIPTION

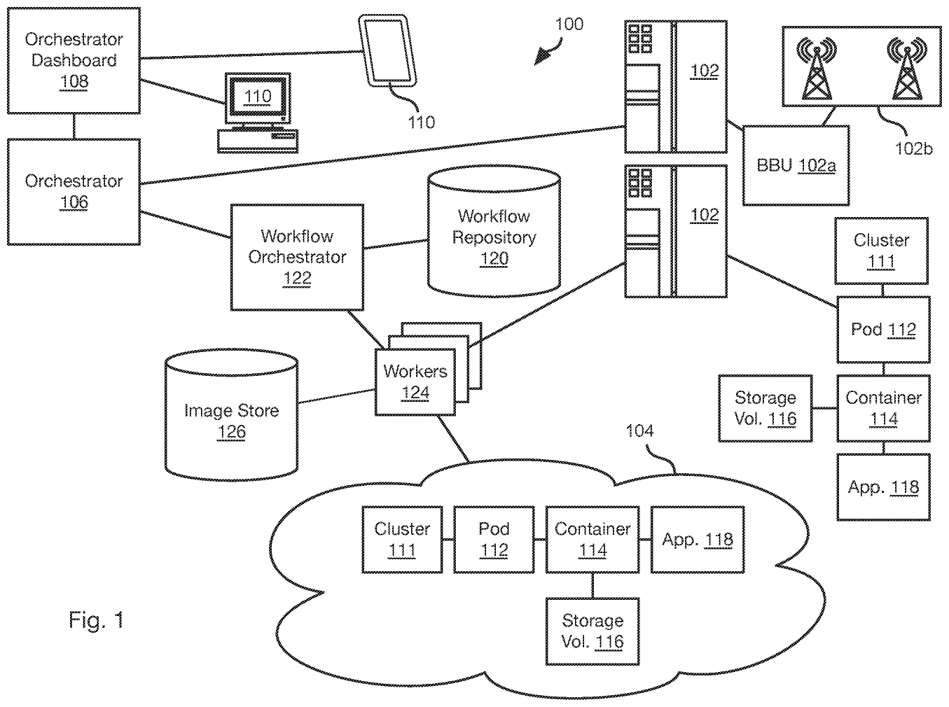

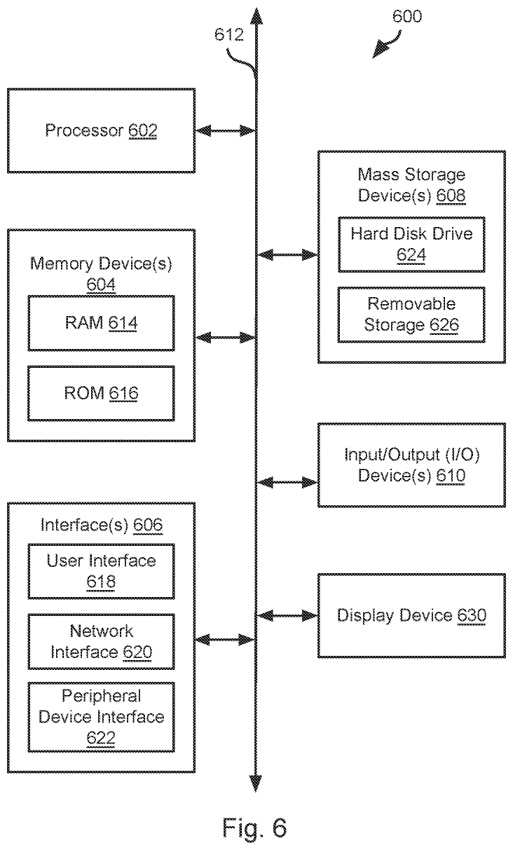

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 600 of FIG. 6.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform.

In some embodiments, some or all of the servers 102 may function as edge servers in a telecommunication network. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.). Servers 102 that function as edge servers may have limited computational resources or may be heavily loaded.

An orchestrator 106 provisions computing resources to application instances 118 of one or more different application executables, such as according to a manifest that defines requirements of computing resources for each application instance. The manifest may define dynamic requirements defining the scaling up of a number of application instances 118 and corresponding computing resources in response to usage. The orchestrator 106 may include or cooperate with a utility such as KUBERNETES to perform dynamic scaling up and scaling down the number of application instances 118.

An orchestrator 106 may execute on a computer system that is distinct from the servers 102 and is connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102. For example, the gateway address and source address may be provided and the operating system installed using the approach described in U.S. application Ser. No. 16/903,266, filed Jun. 16, 2020 and entitled AUTOMATED INITIALIZATION OF SERVERS, which is hereby incorporated herein by reference in its entirety.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QOS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

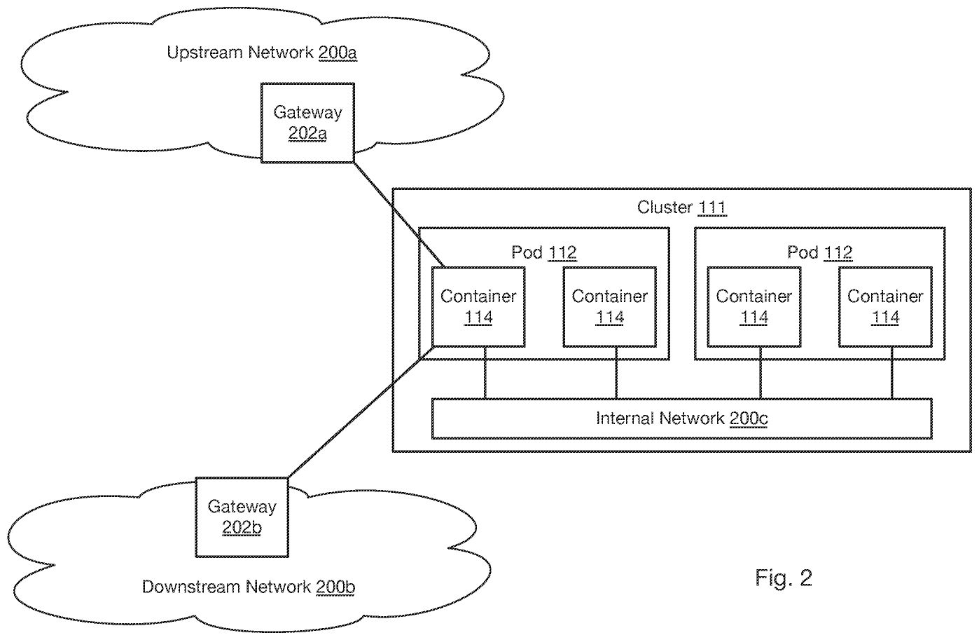

Referring to FIG. 2, A cluster 111 may include components, e.g., one or more pods 112 and one or more containers 114) executing on hosts that are connected to a common internal network 200c. As used herein “host” may be understood as referring to a server 102, a unit of computing resources of the cloud computing platform 104, or a virtual machine executing on a server 102 or in the cloud computing platform 104. The internal network 200c may be a local network, e.g., LAN, or a virtual network connecting components executing on a common host. The internal network 200c may be a virtual network implemented by the cloud computing platform. The internal network 200c may be the backplane of a chassis to which multiple servers 102 are attached. Communication over the internal network 200c may use a utility such as CALICO to provide for secure communication and routing over the internal network 200c.

The cluster 111 may also be part of a larger network, such as a network including an upstream network 200a and a downstream network 200b. For example, the upstream network may connect the cluster 111 to one or more back-end servers 102 whereas the downstream network 200b is a client facing network including the Internet or connecting the cluster 111 to the Internet. Each network 200a, 200b may be accessible by one or more corresponding gateways 202a, 202b that are devices configured to receive connections and traffic from external to the networks 200a, 200b. The illustrated configuration is exemplary only. A cluster 111 may connect to any number of external networks having any number of purposes.

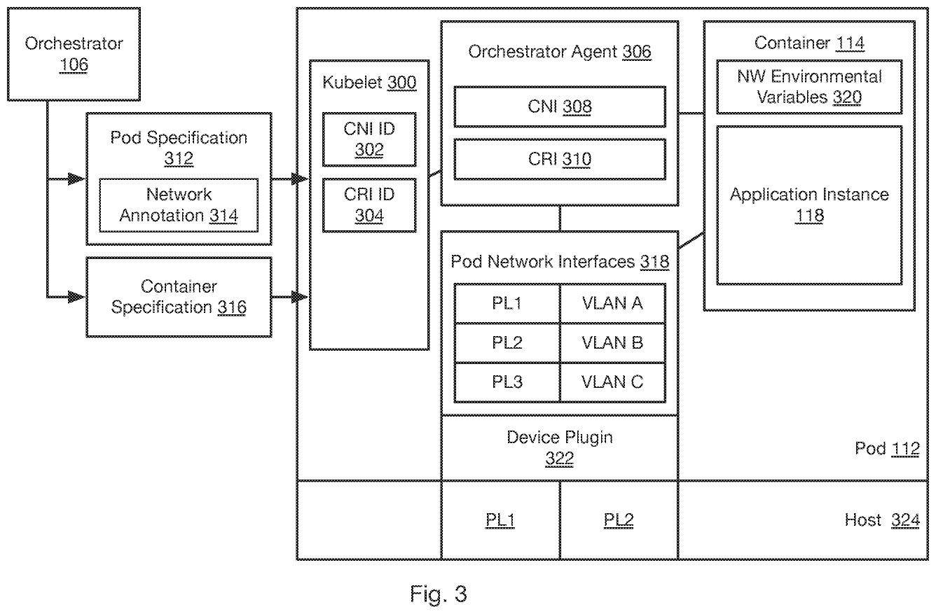

Referring to FIG. 3, a pod 112 may have some or all of the illustrated attributes in order to enable containers 114 to communicate with one or more networks, such as one or more external networks 200a, 200b or an internal network 200c of a cluster 111 to which the pod 112 belongs.

The pod 112 may be managed by a Kubelet 300 according to KUBERNETES. The Kubelet 300 may be configured with a container networking interface (CNI) identifier 302 and a container runtime interface (CRI) identifier 304. The CNI identifier 302 and CRI identifier 304 may reference an orchestrator agent 306. The orchestrator agent 306 may interface with the orchestrator 106 to extend the functionality of KUBERNETES. The CNI identifier 302 and CRI identifier 304 may reference components of the orchestrator agent 306 implementing a CNI 308 and CRI 310.

As described in greater detail below, the orchestrator 106 may implement functionality in addition to conventional functions of a CRI and CNI according to KUBERNETES. In a conventional approach, a CNI is called by a Kubelet to set up network interfaces for containers of a pod. A CRI is called by the Kubelet to instantiate a container and to perform other tasks with respect to a container, such as starting, suspending, and stopping a container.

The orchestrator 106 may pass a pod specification 312 to a Kubelet 300 in order to instruct the Kubelet 300 to instantiate a pod 112. The orchestrator 106 may pass the pod specification 312 to the Kubelet 300 directly or by way of a KUBERNETES master for the cluster 111 to which the pod 112 belongs. For example, the KUBERNETES may instantiate the Kubelet 300 and pass the pod specification 312 to the Kubelet 300 in response to an instruction from the orchestrator 106. The orchestrator 106 may also pass one or more container specifications 316 to the Kubelet 300 either directly or by way of a KUBERNETES master. The container specification 316 may be a separately transmitted data object or part of the pod specification 312.

The pod specification 312 specifies attributes of the pod 112 to be instantiated and may include any such attributes known in the art. In addition, a pod specification 312 according to the approach described herein includes a network annotation 314. The network annotation 314 is an annotation that will be passed by the Kubelet 300 to the CNI 308 when invoking the CNI 308. The network annotation 314 may include additional information than is included in a conventional call to a CNI. For example, in addition to information for setting up network interfaces 318 for the pod 112, the network annotation 314 may include network environmental variables 320 that can be used to configure the containers 114 of the pod 112 to use the network interfaces 318 for particular purposes, such as to use specific networks as discussed in greater detail below.

Upon being called by the Kubelet 300 and passed the network annotation 314, the CNI 308 of the orchestrator agent 306 may configure the pod network interfaces 318. As an example, the network interfaces may include an association between one or more virtual local area networks (VLAN) A-C and physical links (PL1, PL2) of a host 324 on top of which the VLAN A-C are implemented. The pod network interfaces 318 may be implemented with respect to a device plugin 322 of the pod 112 that provides an interface to the physical links PL1, PL2.

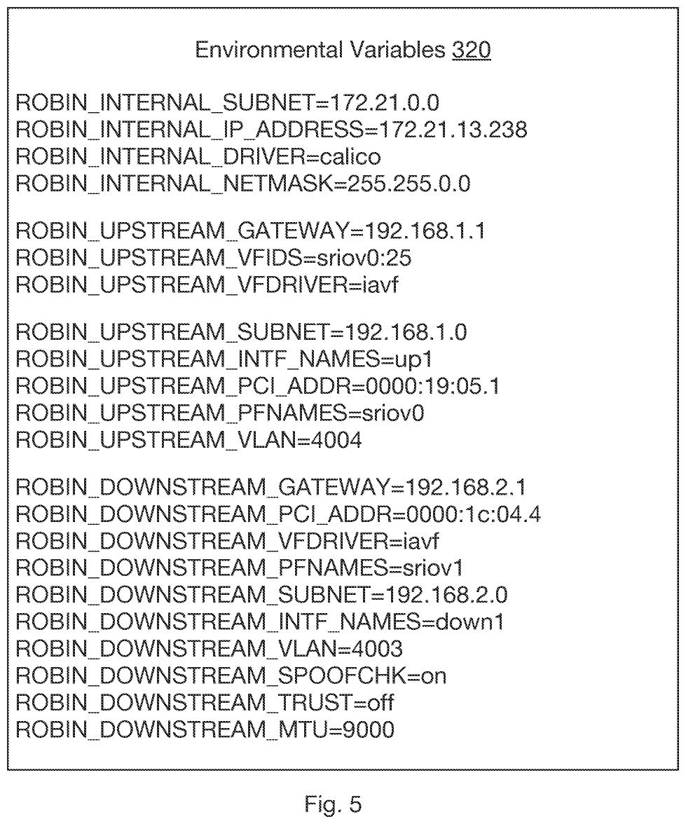

In response to the container specification 316, the Kubelet 300 calls the CRI 310, which is part of, or coordinates with, the orchestrator agent 306. The orchestrator agent 306 will have previously received the network annotation 314 when the CNI 308 was called. Upon calling of the CRI 310, the CRI 310 will instantiate the container 114 and the application instance 118 hosted thereby as directed in the container specification 316. The CRI 310 will additionally extract one or more network environmental variables 320 from the network annotation 314 and add these environmental variables 320 to the container 114. Examples of these environmental variables 320 are described below with respect to FIG. 5.

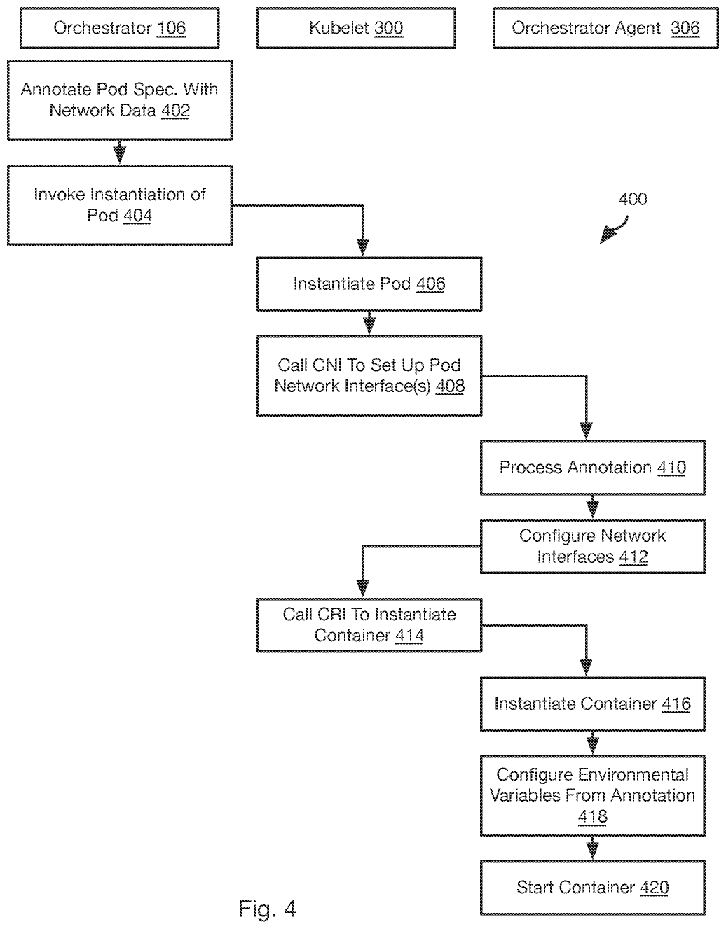

FIG. 4 illustrates a method 400 for instantiating a pod 112 and container 114 with the injection of network environmental variables 320 into the container 114.

The orchestrator 106 annotates 402 a pod specification 312 with a network annotation 314. The pod specification 312 specified how to run containers 114 of the pod 112 instantiated from the pod specification 312. The pod specification 312 may define the implementation a logical host for multiple containers 114. The pod specification 312 may include a set of namespaces, a file system (e.g., built on a storage volume 116), or other data structures that are shared by containers 114 belonging to the pod 112 instantiated from the pod specification.

The network annotation 314 includes a set of VLAN identifiers, mappings of the VLAN identifiers to physical links of one or more hosts, and network environmental variables 320 to be injected into the containers 114 hosted by the pod 112 instantiated from the pod specification 312.

The orchestrator 106 then invokes 404 instantiation of the pod 112 either directly or through a KUBERNETES master. The pod is then instantiated 406. Instantiation 406 of the pod 112 may include instantiating, by the orchestrator 106, the KUBERNETES master, or some other utility, the Kubelet 300 on a host followed by the Kubelet 300 implementing the pod specification 312 on the host.

The Kubelet 300 may call 408 the CNI 308 of the orchestrator agent 306, such as due to the pod specification 312 including the CNI identifier 302 referencing the CNI 308. The orchestrator agent 306 may have been previously installed on the host or may be installed as part of step 406.

In response to the call to the CNI 308, the orchestrator agent 306 may process 410 the network annotation 314 in order to obtain data describing the network interfaces 318 and to extract the network environmental variables 320. The network environmental variables 320 may be stored for subsequent use in memory or persistent storage. The CNI 308 uses the network data to configure 412 the network interfaces 318 as described above, including associating VLANs with physical links of the host 324.

The Kubelet 300 may call 414 the CRI 310 of the orchestrator agent 306 to instantiate one or more containers 114 of the pod 112 according to a container specification 316 received from the orchestrator 106, a KUBERNETES master, or included in the pod specification 312. In response, the orchestrator agent 306 instantiates 416 a container 114 as specified in the container specification 316, including instantiating an application instance 118 to be hosted by the container 114. The orchestrator agent 306 further configures 418 the network environmental variables 320 of the container 114 according to the network annotation 314.

The orchestrator agent 306 may then start 420 execution of the one or more containers 114. The one or more containers 114 may then invoke entrypoints of the application instances 118 hosted thereby in order to commence execution. The application instances 118 may then communicate over any of the networks 200a, 200b, 200c using the network environmental variables 320.

FIG. 5 illustrates an example listing of network environmental variables 320 for a network including an upstream network 200a, downstream network 200b, and an internal network 200c.

For example, for the internal network 200c, the network environmental variables 320 may include a subnet IP address, internal IP address assigned to the container 114, an identifier of the utility being used to perform network communication (e.g., CALICO), and an internal network mask.

For the upstream network 200a, the network environmental variables 320 may include an address of the gateway 202a, a virtual function identifier for the VLAN to be used by the container for an upstream interface to the upstream network 200a, and an identifier of a virtual function driver.

The network environmental variables 320 for the upstream network 200a may further include a subnet IP address, a name of the upstream interface, a peripheral component interconnect (PCI) address on a physical component (e.g., network interface controller) implementing the upstream interface, a name of the physical device of the host 324 implementing the upstream interface, and an identifier of the VLAN to be used for communication over the upstream interface.

For the downstream network 200b, the network environmental variables 320 may include an address of the gateway 202b, a PCI address on a physical component (e.g., network interface controller) implementing a downstream interface to the downstream network 200b, a name of a virtual function driver to be used by the container 114 when communicating over the downstream interface, a name of the physical device of the host 324 implementing the downstream interface, a subnet IP address, an identifier of the downstream interface, and an identifier of the VLAN to be used for communication over the downstream network 200b.

The network environmental variables 320 for the downstream network 200b may further include parameters controlling communication over the downstream network 200b, such as whether to perform spoof checks, whether the downstream network 200b is trusted, the maximum transmission unit (MTU) over the downstream network 200b, or other parameters.

The network environmental variables 320 shown in FIG. 5 are exemplary only. The network environmental variables 320 for communication over any given network 200a, 200b, 200c may include values for any of the above-described variables listed above. Likewise, other values that may be helpful to enable an application instance 118 to establish network connections and communicate over any of the networks 200a, 200b, 200c may also be included in the environmental variables 320.

Once configured with the environmental variables 320, the containers 114 may address communication over a VLAN and physical component indicated in the network environmental variables 320 using the names, addresses, and/or identifiers indicated in the network environmental variables 320 as described above.

FIG. 6 is a block diagram illustrating an example computing device 600. Computing device 600 may be used to perform various procedures, such as those discussed herein. The servers 102, orchestrator 106, workflow orchestrator 122, and cloud computing platform 104 may each be implemented using one or more computing devices 600. The orchestrator 106, and workflow orchestrator 122 may be implemented on different computing devices 600 or a single computing device 600 may both of the orchestrator 106, and workflow orchestrator 122.

Computing device 600 includes one or more processor(s) 602, one or more memory device(s) 604, one or more interface(s) 606, one or more mass storage device(s) 608, one or more Input/output (I/O) device(s) 610, and a display device 630 all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM) 614) and/or nonvolatile memory (e.g., read-only memory (ROM) 616). Memory device(s) 604 may also include rewritable ROM, such as Flash memory.

Mass storage device(s) 608 include various computer readable media, such as magnetic tapes, magnetic disks, optical disks, solid-state memory (e.g., Flash memory), and so forth. As shown in FIG. 6, a particular mass storage device is a hard disk drive 624. Various drives may also be included in mass storage device(s) 608 to enable reading from and/or writing to the various computer readable media. Mass storage device(s) 608 include removable media 626 and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Display device 630 includes any type of device capable of displaying information to one or more users of computing device 600. Examples of display device 630 include a monitor, display terminal, video projection device, and the like.

Interface(s) 606 include various interfaces that allow computing device 600 to interact with other systems, devices, or computing environments. Example interface(s) 606 include any number of different network interfaces 620, such as interfaces to local area networks (LANs), wide area networks (WANs), wireless networks, and the Internet. Other interface(s) include user interface 618 and peripheral device interface 622. The interface(s) 606 may also include one or more peripheral interfaces such as interfaces for printers, pointing devices (mice, track pad, etc.), keyboards, and the like.

Bus 612 allows processor(s) 602, memory device(s) 604, interface(s) 606, mass storage device(s) 608, I/O device(s) 610, and display device 630 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. An apparatus comprising:
a computing device including one or more processing devices and one or more memory devices operably coupled to the one or more processing devices, the one or more memory devices storing executable code that, when executed by the one or more processing devices, causes the one or more processing devices to:
receive a pod specification including a network annotation;
instantiate a pod according to the pod specification;
configure one or more network interfaces for the pod according to the network annotation;
call a container runtime interface to instantiate one or more containers in the pod;
instantiate, by the container runtime interface, the one or more containers; and
configure, by the container runtime interface, the one or more containers with one or more environmental variables from the network annotation for controlling communication over the one or more network interfaces.

2. The apparatus of claim 1, wherein the one or more network interfaces include one or more virtual local area networks (VLANs) implemented on a physical link of the computing device.

3. The apparatus of claim 2, wherein the one or more environmental variables include identifiers of the VLANs.

4. The apparatus of claim 2, wherein the one or more environmental variables include virtual function identifiers of the VLANs.

5. The apparatus of claim 1, wherein the one or more environmental variables include a gateway address for an external network.

6. The apparatus of claim 1, wherein the one or more environmental variables include an address in an internal network of the pod.

7. The apparatus of claim 1, wherein the one or more environmental variables include an address of a networking component of the computing device.

8. The apparatus of claim 7, wherein the address of the networking component is a peripheral component interconnect (PCI) address.

9. The apparatus of claim 1, wherein the pod is a KUBERNETES pod.

10. The apparatus of claim 1, wherein the computing device is part of a cloud computing platform.

11. A method comprising:
receiving, by a computer system, a pod specification including a network annotation;
instantiating, by the computer system, a pod according to the pod specification;
configuring, by the computer system, one or more network interfaces for the pod according to the network annotation;
calling, by the computer system, a container runtime interface to instantiate one or more containers in the pod;
instantiating, by the computer system, using the container runtime interface, the one or more containers; and
configuring, by the computer system, using the container runtime interface, the one or more containers with one or more environmental variables from the network annotation for controlling communication over the one or more network interfaces.

12. The method of claim 11, wherein the one or more network interfaces include one or more virtual local area networks (VLANs) implemented on a physical link of the computer system.

13. The method of claim 12, wherein the one or more environmental variables include identifiers of the VLANs.

14. The method of claim 12, wherein the one or more environmental variables include virtual function identifiers of the VLANs.

15. The method of claim 11, wherein the one or more environmental variables include a gateway address for an external network.

16. The method of claim 11, wherein the one or more environmental variables include an address in an internal network of the pod.

17. The method of claim 11, wherein the one or more environmental variables include an address of a networking component of the computer system.

18. The method of claim 17, wherein the address of the networking component is a peripheral component interconnect (PCI) address.

19. The method of claim 11, wherein the pod is a KUBERNETES pod.

20. The method of claim 11, wherein the computer system is part of a cloud computing platform.
